(19) United States
(12) Patent Application Publication
(10) Pub. No.: US 2010/0229052 A1
(43) Pub. Date: Sep. 9, 2010

(54) RESOLVING ASYNCHRONOUS VALIDATION ERRORS

(75) Inventors: Andrew R. Cuneo, Seattle, WA (US); Benjamin Worline, Duvall, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/783,581

(22) Filed: May 20, 2010

Related U.S. Application Data
(63) Continuation-in-part of application No. 11/971,206, filed on Jan. 8, 2008.

(51) Int. Cl. G06F 11/07

(52) U.S. Cl. 714/57; 714/E11.025

(57) ABSTRACT

Architecture that facilitates asynchronous error handling of validation failures, which enables rapid editing in web applications without forcing the end user to wait for server responses or interrupting successive edits. A technical infrastructure is provided that tracks changes over time as well as marks and resolves validation failures. A user interface creates and presents visual cues for validation failures on both a row and cell granularity. Cell-level and row-level validation failures are processed as well as contextually relevant errors and messages. The architecture affords for cycling through multiple errors, and hiding error details unless interacted with by the end user. Support is provided for rapid and type safe editing in a web-based environment and for non-blocking validation failures.

### CROSS-REFERENCE TO RELATED APPLICATIONS

This application is a Continuation-in-Part of pending U.S. patent application Ser. No. 11/971,206 entitled “ASYNCHRONOUS MULTI-LEVEL UNDO SUPPORT IN JAVASCRIPT GRID” and filed Jan. 8, 2008, the entirety of which is incorporated by reference herein.

### BACKGROUND

Modern software applications oftentimes have requirements related to how data is stored. Validators are often used to ensure that the data stored is consistent with the allowable values for a particular type of field. In applications which store and manipulate data in an asynchronous manner (notably, modern web applications) this is problematic because the validation also occurs asynchronously. Thus, a user may have moved elsewhere in the application and continued editing data (while the asynchronous validation was occurring) and then find out later that the previous edit is actually invalid. Due to the asynchronous nature of the validation operation traditional mechanisms for surfacing errors (e.g., dialogs, alerts) can be interruptive, since a user has moved on to another operation and the message associated with the validation error may not be contextually relevant.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates asynchronous error handling of validation failures, which enables rapid editing in web applications without forcing the end user to wait for server responses or interrupting successive edits. The solution provides both for the technical infrastructure for tracking changes over time as well as marking and resolving validation failures. The associated and developed user interface creates visual cues for validation failures on both a row and cell granularity.

Cell-level and row-level validation failures are provided as well as contextually relevant errors and messages. The architecture affords for cycling through multiple errors, and hiding error details unless interacted with by the end user. Support is provided for rapid and type safe editing in a web-based environment and for non-blocking validation failures.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates computer-implemented undo system.

FIG. 2 illustrates an implementation of a client-server system that provides multi-level data change reverse operations.

FIG. 3 illustrates an example of asynchronous undo/redo operations on data.

FIG. 4 illustrates the final data updates based on the use of change keys to address asynchronous out-of-order change processing.

FIG. 5 illustrates a change tracker as part of the change component and an undo stack as part of the reverse component.

FIG. 6 illustrates the initial grid state of data in the grid, stack state of the undo stack, and tracker state of the change tracker.

FIG. 7 illustrates an implicit change and the effects on the stack state and tracker state.

FIG. 8 illustrates a change in the task name of the grid data and the effects on the undo stack and change tracker.

FIG. 9 illustrates execution of an undo operation.

FIG. 10 illustrates a computer-implemented method of providing reverse operations in data.

FIG. 11 illustrates a method of processing explicit/implicit changes.

FIG. 12 illustrates a computer-implemented method of providing reverse operations in data.

FIG. 13 illustrates a validation and error processing system in accordance with the disclosed architecture.

FIG. 14 illustrates a process that creates a change object in response to a user change in the grid.

FIG. 15 illustrates a process that employs validators to validate data associated with the fields of the grid.

FIG. 16 illustrates a process that performs consumer type validation.

FIG. 17 illustrates a process that generates property type validation results.

FIG. 18 illustrates a process for further customized validation.

FIG. 19 illustrates a user interface that presents messages and visual cues related to validation at the cell level.

FIG. 20 illustrates a computer-implemented validation and error processing method in accordance with the disclosed architecture.

FIG. 21 illustrates additional aspects of the method of FIG. 20.

FIG. 22 illustrates additional aspects of the method of FIG. 20.

FIG. 23 illustrates a block diagram of a computing system that executes asynchronous validation and error processing in accordance with the disclosed architecture.

FIG. 24 illustrates a schematic block diagram of a computing environment that executes asynchronous validation and error processing.

### DETAILED DESCRIPTION

In the context of web application error handling, the ability to return errors introduced during development can be a particularly time-saving goal. Consider a web application where a user interacts with a server to access a grid, or a type of web application that is grid-centric in terms of editing, to perform editing on fields that are intended to have a certain kind of structure for advertisements, numbers, percents, etc. Local validation can be made relatively trivial by scripting, where possible. However, in many cases, there is a need to go back to the server to perform validation. This means that input is made, and it may take a relatively long time to receive a response from the server that the validation is successful. Moreover, it is not efficient to block the user from continuing to edit while waiting for the validation response from the server.

The disclosed architecture allows the user to continue editing while one or more previous edits are being validated. While the request is in-process to the server the user can continue editing, and even when the request is back from the server, the user can continue editing. Thus, the user can fix the value asynchronously well after actual entry of the end value, and another edit thereon. The validation notification returns as soon as possible although if not timely received, the user is not prevented from continuing to work. The user is not required to take any action on the notification. The user can choose to wait for it, or interact in some way to obtain the notification before moving forward to other work.

The disclosed architecture provides asynchronous error handling of validation which enables rapid editing in web applications without forcing the end user to wait for server responses before moving forward with editing or interrupting successive edits. The technical infrastructure tracks changes as well as marks and resolves validation failures. A user interface creates visual cues for validation failures on both a row and cell granularity. For example, in the event a validation error occurs the ““offending” (received a validation error) cell can be emphasized (e.g., by color, bolding, dashed border lines, animation, etc.) and a clickable error icon placed in association with the offending cell, such as in the row header that toggles through the set of all errors in the application. When an offending cell is focused, a contextually relevant error message can be displayed by the cell to indicate the specific error. Each of the edits can be tracked according to time, and as previous changes fail/succeed the results of the edit operations appear in the grid.

Cell-level and row-level validation failures are provided as well as contextually relevant errors and messages. The architecture affords for cycling through multiple errors, and hiding error details unless interacted with by the end user. Support is provided for rapid and type safe editing in a web-based environment and for non-blocking validation failures.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

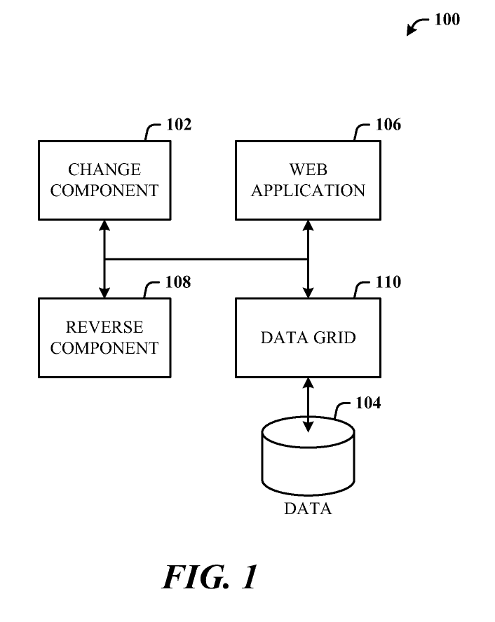

FIG. 1 illustrates a computer-implemented undo system 100. The system 100 includes a change component 102 for tracking asynchronous changes to data 104 via a web application 106. The system 100 further includes a reverse component 108 for performing reverse operations (e.g., undo, redo) on the data changes to the data 104 to previous states. The changes to the data 104 can be made via a data grid 110. The changes to the data 104 can be made manually or programmatically via the grid 110.

The application 106 instantiates and configures the grid 110. The grid 110 is a tabular representation of data that is stored in the application 106, supporting editing and visualization. A change is the before and after versions of a cell's data, plus the action that was required to cause the cell value to change.

In one embodiment, the web application 106 is a browser application via which changes are made to a web page hosted by a server. The user can then exercise multi-level undo/redo reverse operations for changes made to the webpage document.

In another implementation, the web application 106 is a browser that allows a user to interact with local data, rather than network data and exercise reverse operations such as multi-level undo/redo.

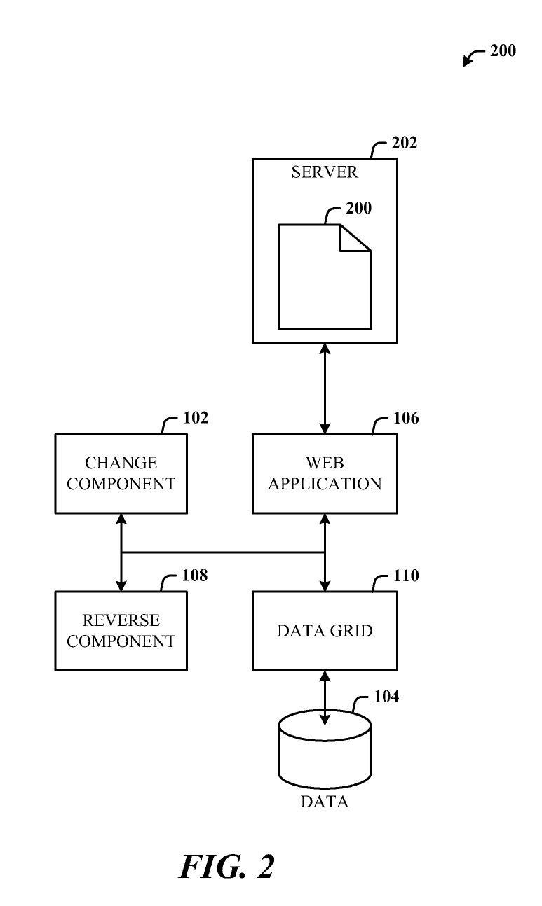

FIG. 2 illustrates an implementation of a client-server system 200 that provides multi-level data change reverse operations. The system 200 shows the system 100 of FIG. 1, to wit, the change component 102 for tracking asynchronous changes to the data 104 via the web application 106, and the reverse component 108 for performing reverse operations (e.g., undo, redo) on the data changes to previous states. The data changes are made manually and/or programmatically via the data grid 110. Here, the data changes are applied to a web document (e.g., webpage) 200 of a web server 202. As edits are passed into the grid 110, change notifications are sent to the server 202 via the application 106 for asynchronous validation. Once validated, the changes are sent back to the grid 110 via the application 106 as updates to the data 104.

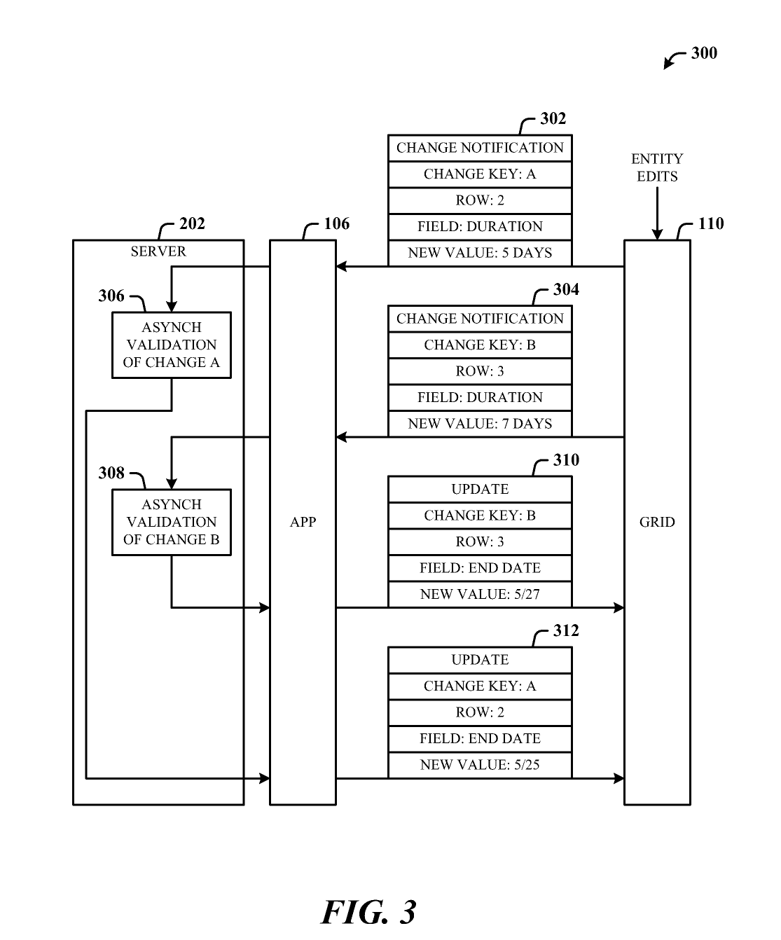

FIG. 3 illustrates an example 300 of asynchronous undo/redo operations on data. An asynchronous change is a change that requires any number of asynchronous validations or augmentations. When an entity makes changes to the grid data, the result of this change is a notification to the application 106. Contained within this notification is an order (or change) key. The application 106 consumes the notification and then can append new changes based on some synchronous or asynchronous computations (e.g., scheduling) by calling an update function with that order key. The application 106 is free to use the order key at any point in the future to attach further updates to this change. These updates are properly collected together for undo/redo.

Here, two changes, denoted as A and B, are entered into the grid 110 that require asynchronous validation. When the edits are made, the changes are captured in order by the grid 110. Each change is tagged with an order key. For example, change A is tagged with an order key A (also denoted change key A) and the second change B (later in time than change A) is denoted with a change key B. When a data change is made, the grid 110 detects this and sends a notification to the application 106 (e.g., a browser), which the application 106 then sends the notification to the server 202 for validation. The validation process at the server 202 can occur out-of-order, or once the validation has competed, the server can send the previously ordered validation out-of-order. Thus, the order keys facilitate ordering the changes at the grid 110.

In this example, a first change notification request 302 is sent from the grid 110 to the application 106 to account for the data change A, made in a second row to a column having a field labeled Duration, and a new value of the duration set to five days. In a subsequent data edit, the grid 110 sends a second change notification request 304 to the application 106 to account for the data change B, made in a third row to a column having a field labeled Duration, and a new value of the duration set to seven days. The change notification requests (302 and 304) are sent to the application 106 in order (e.g., change A before change B). The application 106 then forwards the notification requests (302 and 304) to the server 202, the server 202 validates the change requests (302 and 304) asynchronously, and returns the validations back to the application 106.

Here, the server 202 begins a first validation process 306 for the first change notification request 302. Next, the server 202 receives and begins a second validation process 308 for the second change notification request 304. The server 202 completes the second validation process 308 before the first validation process 306. Thus, a second update response 310 is sent from the server 202 through the application 106 to the grid 110 for updating the associated data. The second update response 310 includes the order key B that signifies the order in which the data change was made relative to the first data change A. The second update response 310 also includes that the change was made in the third row, at a field labeled End Date, and the new value for End Date of 5/27. This corresponds to the new value of seven days in the second change notification request 304.

The server 202 then completes the first validation process 306 and sends a first update response 312 through the application 106 to the grid 110 for updating the associated data. The first update response 312 includes the order key A that signifies the order in which the data change was made relative to the second data change B. The first update response 312 also includes that the change was made in the second row, at a field labeled End Date, and the new value for End Date of 5/25. This corresponds to the new value of five days in the first change notification request 302. Thus, the changes come back from validation out of order (change B before change A).

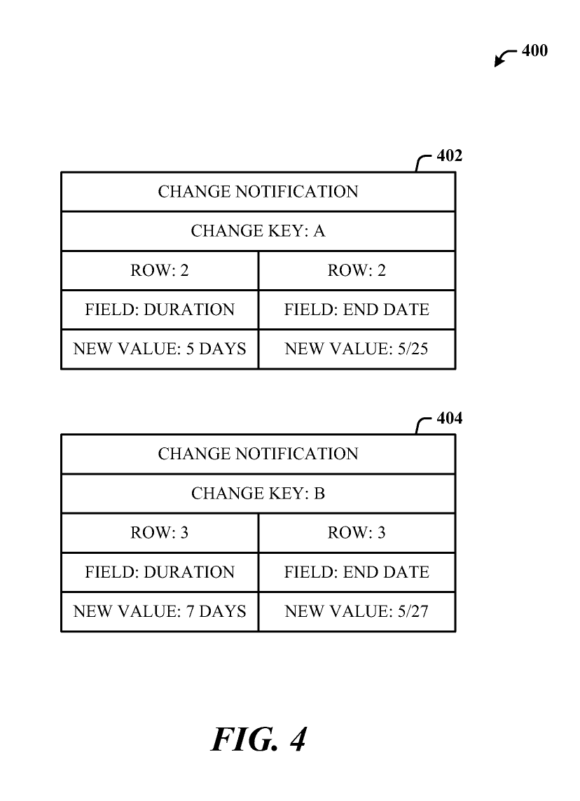

FIG. 4 illustrates the final data updates based on the use of change keys to address asynchronous out-of-order change processing. The results 400 of the requests for the data changes which have occurred since the last save operation are shown. When returned from the server 202, the results are placed and stored in the logical order that the change (or order) keys dictate (change B after change A), rather than the order in which the events actually occurred (change A after change B). Thus, the changes 402 related to change A are stored together and denoted as occurring before change B. Similarly, the changes 404 related to change B are stored together and denoted as occurring after change A.

The undo and redo reverse operations are also handled in this way. Thus, if a user were to select undo, both changes (Duration and End Date) associated with change B would be undone, since that is the last change the user made, as indicated by change key B, even though the update to change A was the last event the grid encountered.

An entity (e.g., a user or system) interacts with the grid to make change to data in the grid, either explicitly or implicitly. An explicit change is a change made to the grid that directly affects data (e.g., changing a start date on a task). An implicit change is a change that is made to the grid that has no effect on the data (e.g., resizing a column).

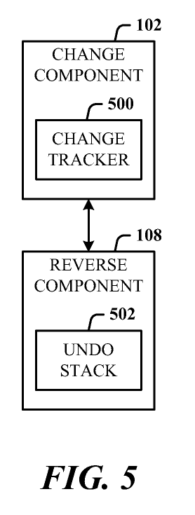

FIG. 5 illustrates a change tracker 500 as part of the change component 102 and an undo stack 502 as part of the reverse component 108. As an entity makes changes to grid data, the type of each change is noted, and functions to execute and undo are placed on the undo stack 502. The undo stack 502 is a data structure that stores an ordered history of the last set of actions. When an undo event happens, operations are removed from the undo stack 502 and reverted until the first explicit change is encountered. The first explicit change is the last action reverted. At this point, the undo operation concludes. Subsequent undo operations are handled in the same manner; an undo command will revert all implicit actions before the next explicit action, and then revert the explicit action.

The effect of this system is that after an undo operation, the visual state of the grid is restored before the undone action. All explicit changes are stored in a separate structure (the change tracker 500) from the undo stack 502. This change tracker 500 can be exported as a collection of cell-level and row-level changes. Property changes are cell-level, while Inserts, Deletes, and (hierarchy outline) Level Changes are row-level.

An explicit change is a change in data. An implicit change is a change in view state. The implicit actions are undone/redone to restore the view to a state where undone/redone data changes can be seen. For example, if cell contents are changed (explicit), then a hierarchy node can be collapsed such that the cell is no longer visible (implicit). Then an Undo function can be selected. The hierarchy node can be re-expanded before reverting the cell contents to see the effect of the Undo operation.

The undo stack 502 and the change tracker 500 are independent structures. When a change occurs, that change is pushed onto the undo stack 502, and an entry for that change is made in the change tracker 500 if the change was explicit. If the change is implicit, the change is not logged in the change tracker 500.

When an undo event occurs, the change is removed from the undo stack 502 and the change tracker 500, and the new value is noted in the change tracker 500. If the change existed in the change tracker 500, that change is removed. If the change does not exist in the change tracker 500, the action to revert the change (which itself is a change) is added to a change log. When a save operation occurs the changes are read from the change tracker 500, committed to the datasource, and the change tracker 500 is cleared.

The effect of this system is that an entity can undo actions that occurred prior to the save event because the information necessary to undo a change is stored in the undo stack 502. Similarly, the change tracker 500 can function in the absence of the undo stack 502.

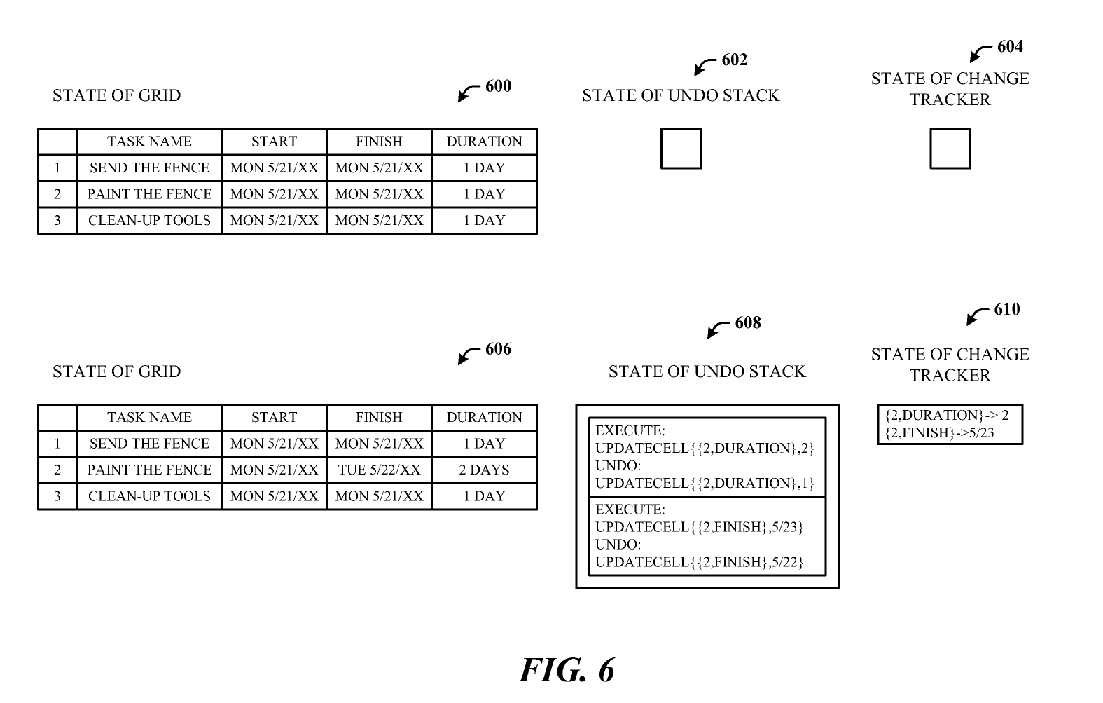

FIGS. 6-9 illustrate a series of diagrams for exemplifying changes that occur in the state of grid data, the undo stack, and the change tracker. FIG. 6 shows the initial grid state 600 of data in the grid, stack state 602 of the undo stack, and tracker state 604 of the change tracker. The changes will occur in rows two and three of the grid data.

The entity then makes an explicit change by deciding that painting the fence should take two days instead of one day. The change grid state 606 includes a change in the second row in the Duration column to two days. In the case of a project as part of a project management application, for example, a change in duration causes a change in the end date, also called Finish (a cascading change). A cascading transaction is created encompassing both changes. Thus, the field information in the second row in the Finish column changes from Mon 5/21/xx to Tue 5/22/xx, as indicated in changed grid state 606.

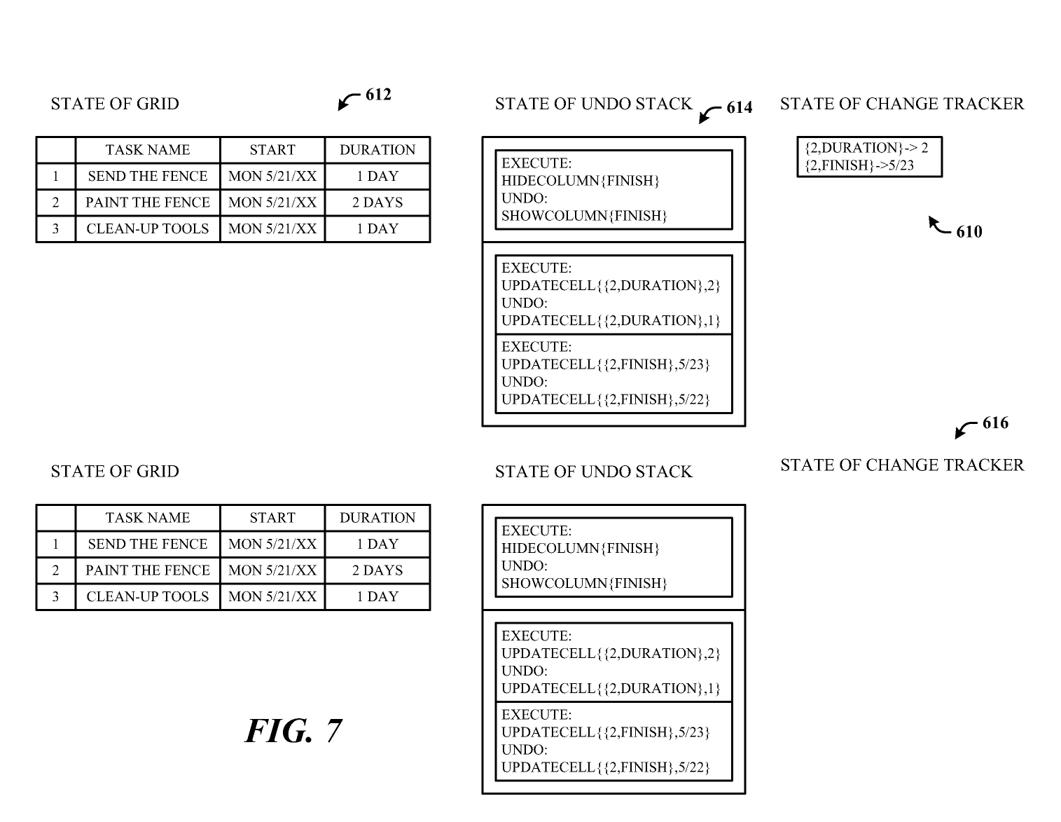

These Duration and Finish changes are pushed onto the undo stack as indicated in the stack state 608. Additionally, the tracker state 610 reflects the changes. FIG. 7 shows an implicit change and the effects on the stack state and tracker state. Here, the entity hides the Finish column thereby changing to the grid state 612, which pushes the change onto the undo stack changing to the stack state 614, but does not change the tracker state 610 of the change tracker. The entity saves the project, which causes the tracker state 610 in the change tracker to be cleared to stack state 616, as the grid's data is now consistent with the server data.

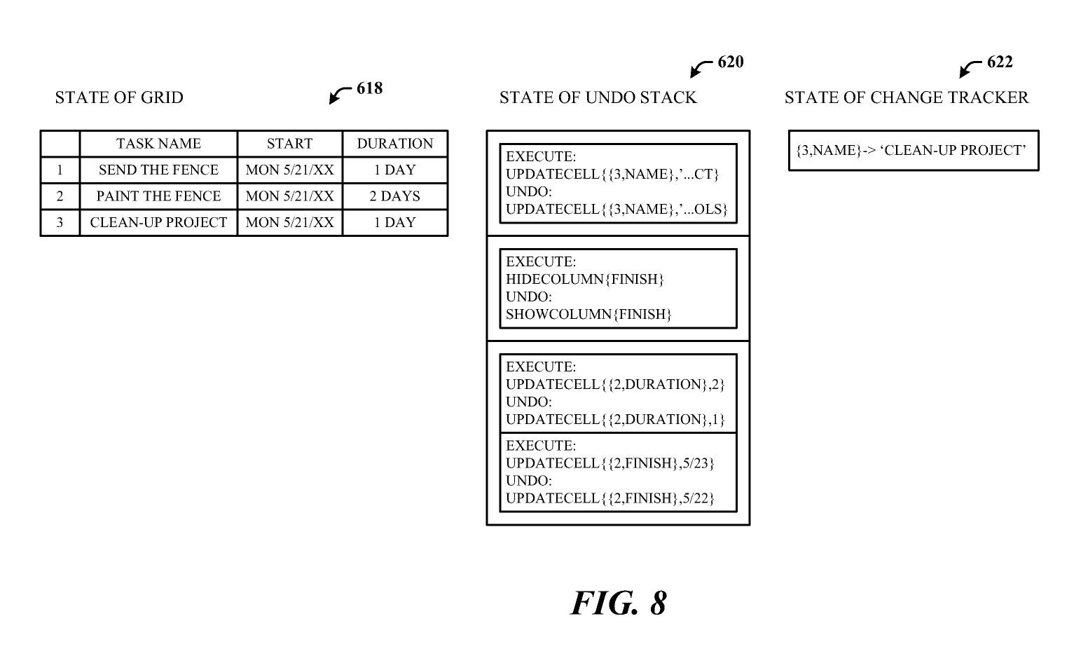

FIG. 8 illustrates a change in the task name of the grid data and the effects on the undo stack and change tracker. The entity changes the grid state 618 based on a change in the task name in row three from ‘Clean-up tools’ to ‘Clean-up project’. The stack state 620 reflects the change pushed onto the stack, and the tracker reflects tracker state 622.

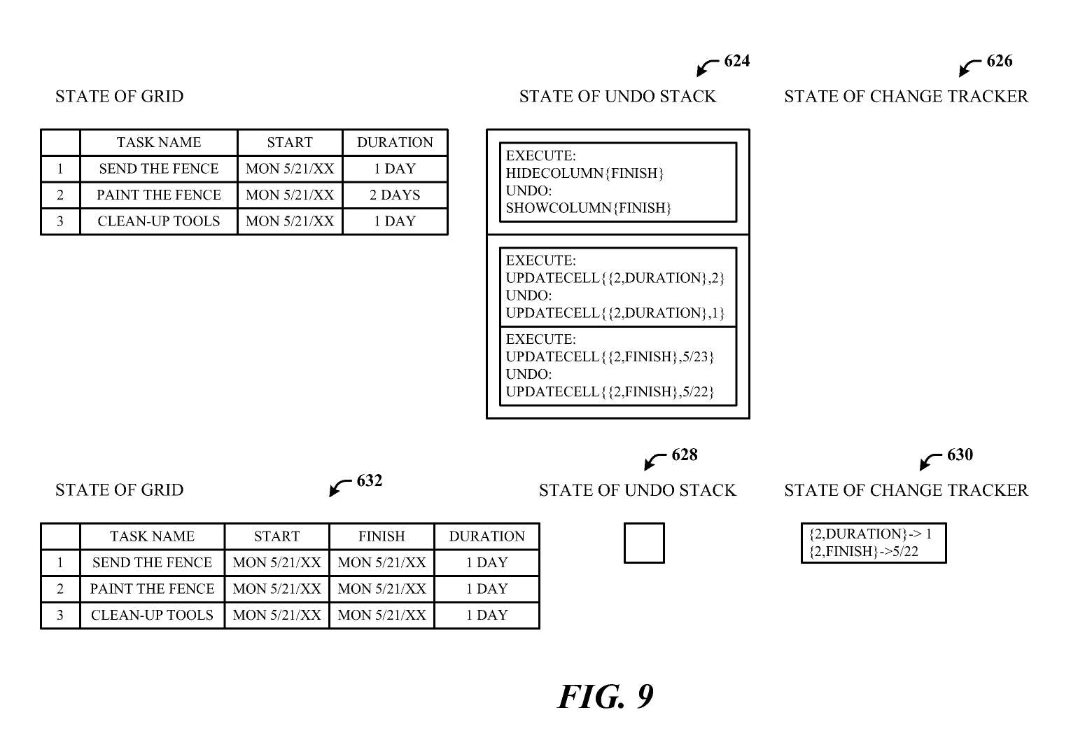

FIG. 9 illustrates execution of an undo operation. The undo reverts the last explicit change by popping the change from the undo stack and the change tracker, as shown in the stack state 622 and tracker state 626 (no change from before). The entity then executes undo once more, which reverts both the implicit change and the remaining explicit change. This cascading effect removes the change from the undo stack to a stack state 628, adds an inverse change to the change tracker to a tracker state 630, and changes the grid state back to grid state 632, which is the same as grid state 600 of FIG. 6.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

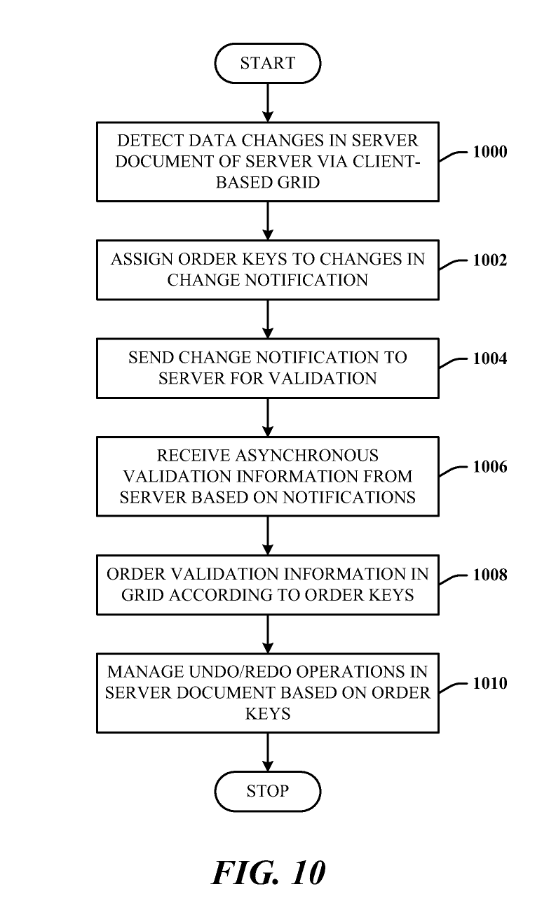

FIG. 10 illustrates a computer-implemented method of providing reverse operations in data. At 1000, data changes in a server document of a server are detected via a client-based grid. At 1002, order keys are assigned to the changes in a change notification. At 1004, the change notifications are sent to the server for validation. At 1006, asynchronous validation information is received from the server based on the notifications. At 1008, the validation information is ordered in the grid according to the order keys. At 1010, undo/redo operations in the server document are managed based on the order keys.

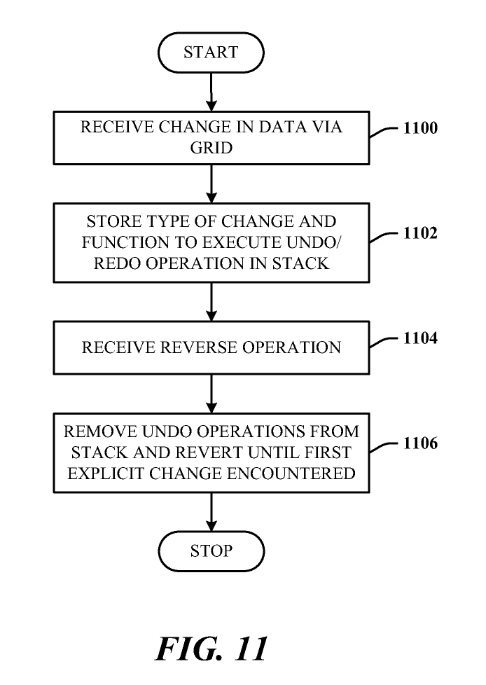

FIG. 11 illustrates a method of processing explicit/implicit changes. At 1100, a change in data is received via a grid. At 1102, the type of change and a function to undo/redo the change are stored in an undo stack. At 1104, a reverse operation (e.g., redo, undo) is received. At 1106, the undo operations are removed from the stack and reverted until the first explicit change is encountered (which is the last action reverted).

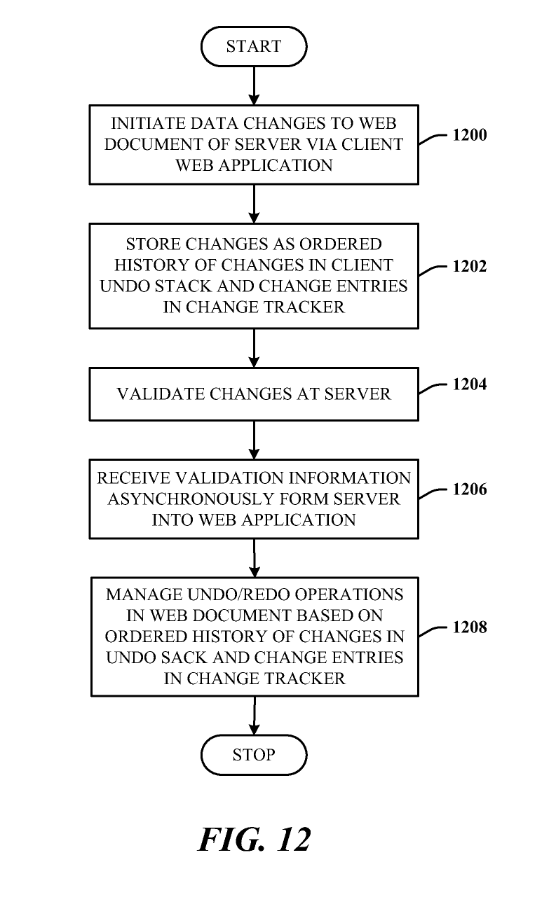

FIG. 12 illustrates a computer-implemented method of providing reverse operations in data. At 1200, data changes are initiated to a web document of a server via a client web application. At 1202, the changes are stored as an ordered history of the changes in a client undo stack and change entries in a client change tracker. At 1204, the changes are validated at the server. At 1206, validation information is received asynchronously from the server into the web application. At 1208, undo/redo operations in the web document are managed at the client based on the ordered history of the changes in the undo stack and the change entries in the change tracker.

### Resolution of Asynchronous Validation Errors

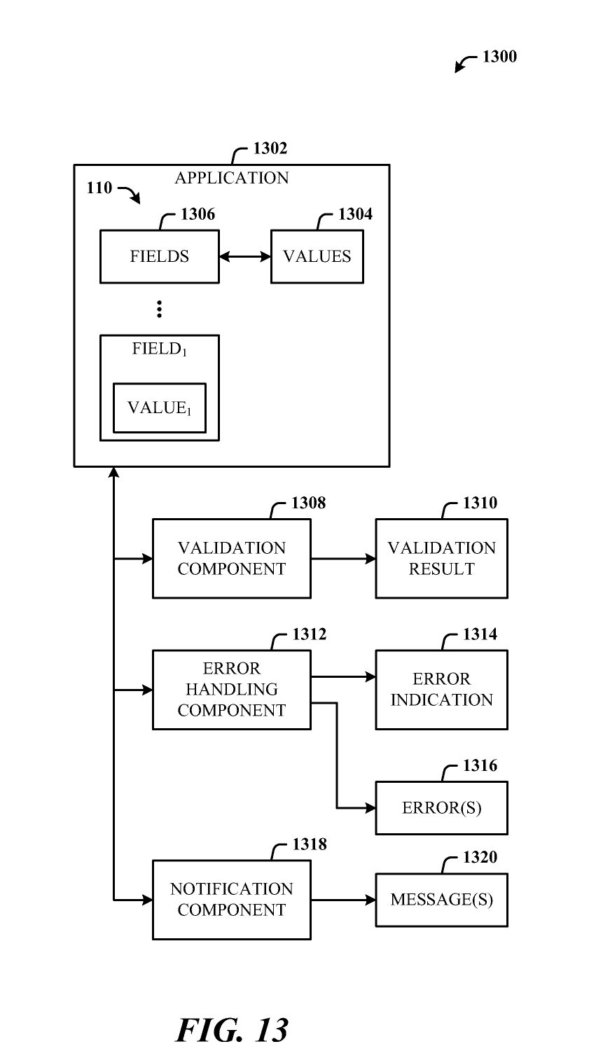

FIG. 13 illustrates a validation and error processing system 1300 in accordance with the disclosed architecture. The system 1300 comprises an application (e.g., web) 1302 that stores and manipulates data asynchronously. The data includes values 1304 in association with fields 1306, such as in the grid 110. A validation component 1308 asynchronously performs validation checks of the association of the values 1304 and the fields 1306 to output a validation result 1310. An error handling component 1312 that generates an error indication 1314 according to the validation result 1310.

The validation component 1308 asynchronously performs validation checks at a cell level of the grid 110 and/or a row level of the grid 110. The error handling component 1312 generates and presents the error indication 1314 in association with a context in which the validation result 1310 is a failure. The error handling component 1312 presents multiple errors 1316 for review in response to user interaction. The manipulation of the data is non-blocked during validation and error handling. The application 1302 can be a web application via which the data is manipulated during an editing session and validation checks are performed asynchronously. The error handling component 1312 populates the grid 110 of field objects asynchronously with corresponding error indications (e.g., error indication 1314) based on respective validation result failures. The system 1300 can further comprise a notification component 1318 that presents a message (of message(s) 1320) in association with the error indication 1314.

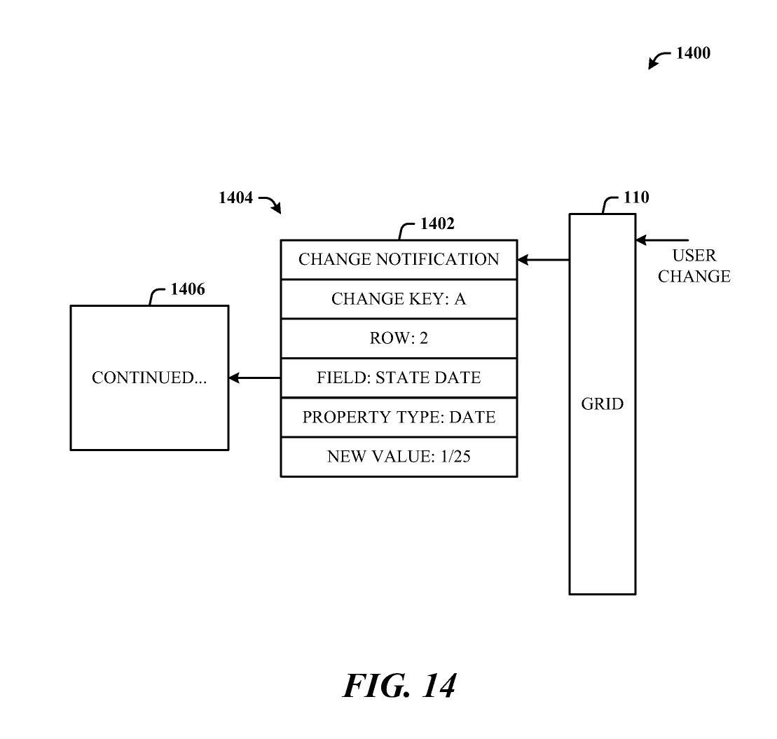

FIGS. 14-18 illustrate an example of resolving asynchronous validation errors.

FIG. 14 illustrates a process 1400 that creates a change object 1402 in response to a user change in the grid 110. When a user makes an edit (user change) inside the grid 110 (e.g., to date data), the relevant metadata 1404 is collected as a change notification in the change object 1402. Here, the metadata 1404 stored in the change object 1402 includes change key, row, field attribute, property type, and value data. The information of the change object 1402 is then passed for other processing such as validation, error handling, and notification, as indicated by a “continued” block 1406 for further validation,

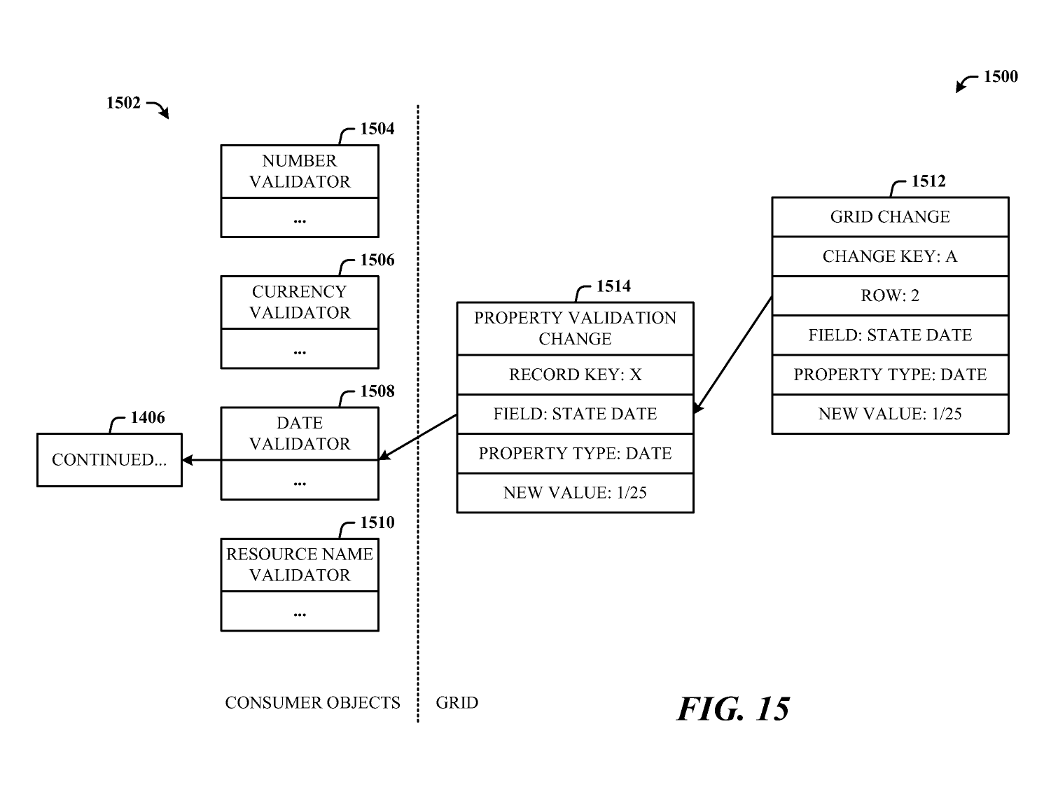

FIG. 15 illustrates a process 1500 that employs validators 1502 to validate data associated with the fields of the grid 110. Based on the property type of this cell, the grid 110 calls a method specified by its owner to validate the change. For example, the validators 1502 can include a number validator 1504, a currency validator 1506, a date validator 1508, and a resource name validator 1510, for example, all of which are considered consumer objects. The validator used (date validator 1508) is matched based on the property type. On the grid side, a grid change object 1512 is created that includes metadata related to the change key, row, field, property type and new value data. Additionally, a property validation change object 1514 is created that includes metadata related to record key, field, property type and new value, for example. Part of the property validation object 1514 is then sent through the property type validation system (comprising the validators 1502).

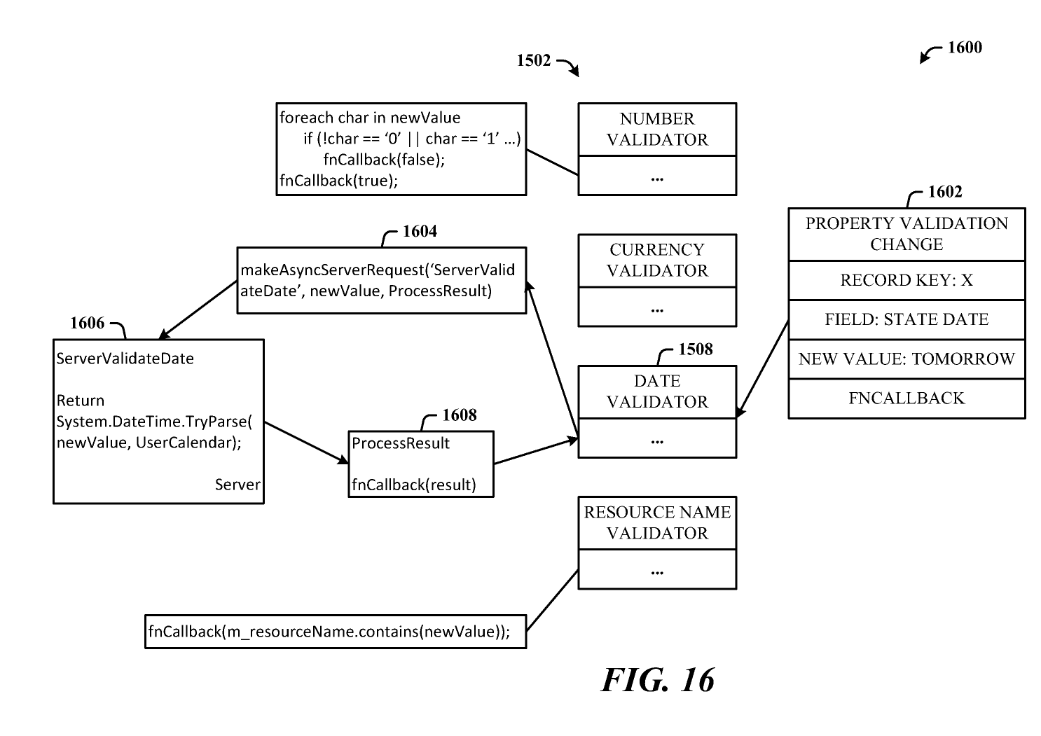

FIG. 16 illustrates a process 1600 that performs consumer type validation. The type validation modules 1502 in this process 1600 can be modeled as javascript objects and the requests for validation use function callbacks (denoted fncallback). This allows for a high degree of flexibility in how a grid consumer can handle validation. Simple logic can be done in javascript as can lookups into local lists (type validation objects can keep their own state) (e.g., refer to number and resource name), and conversions requiring more complex code (e.g., date conversion that use .NET runtime) can be performed on the server (e.g., Date).

Here, a property change validation object 1602 includes metadata related to record key, field, new value, and function callback. The field data is passed to the date validator 1508, which then makes an asynchronous server request 1604 to a server 1606 to validate the date request. The server 1606 replies with a process result 1608 to the date validator 1508.

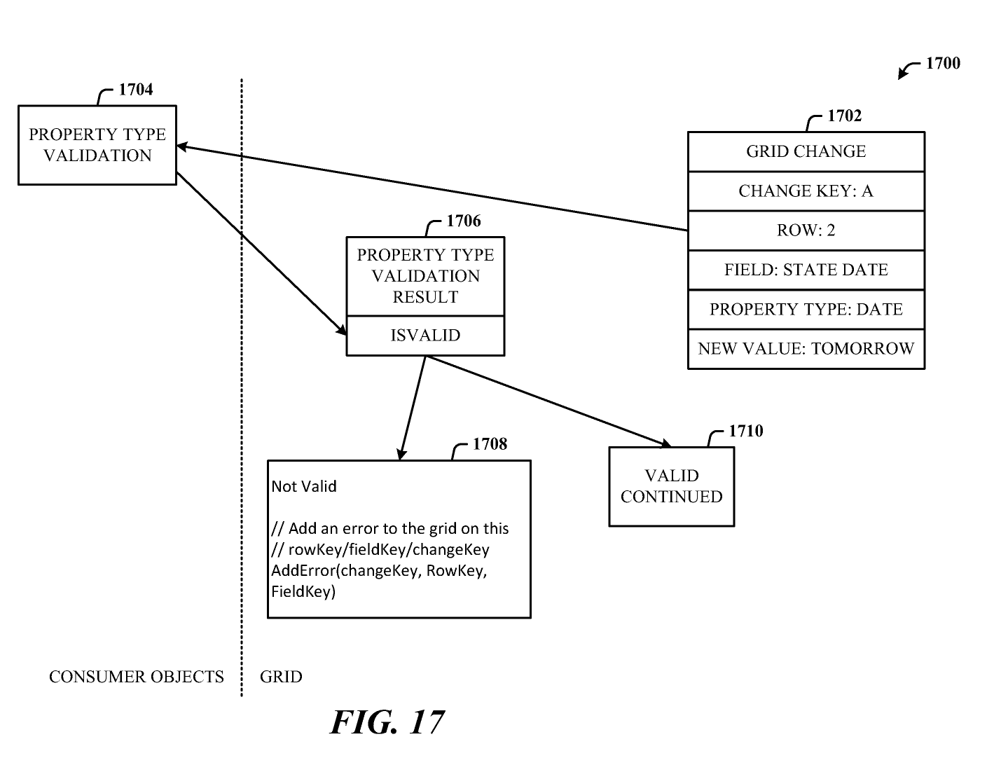

FIG. 17 illustrates a process 1700 that generates property type validation results. Once the client property type has decided that the result is valid (this call may be synchronous or asynchronous), the processing can either be stopped and add an error to the grid error tracking system (that notes the current change key) or continue processing. Here, a grid change object 1702 includes metadata related to change key, row, field, property type and new value. The property type validation 1704 is performed for row 2, property type date. The validate result 1706 is passed back to the grid 110, which can be either not valid 1708 or valid and continued 1710.

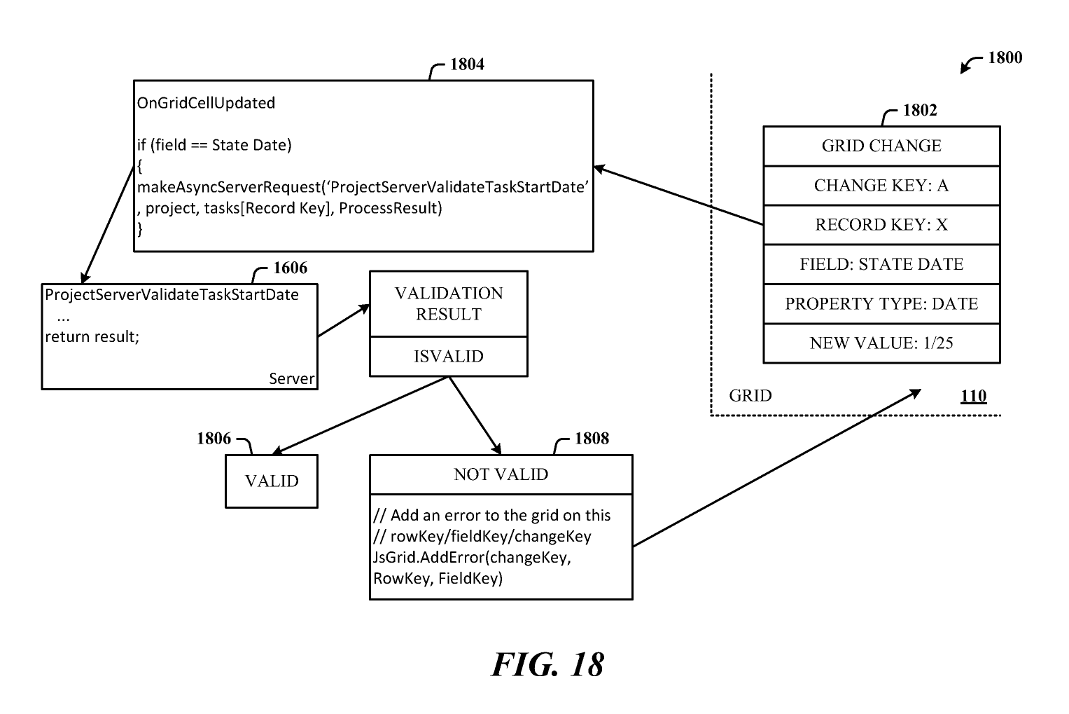

FIG. 18 illustrates a process 1800 for further customized validation. After property type validation has succeeded, an event is fired to which the consumer can listen. Because the consumer can always attach an error to the grid with a change key, the consumer can fire an asynchronous call to the server in this event and then add an error when the call returns from the server.

With respect to change key handling and with multilevel undo, when the grid moves to a change key, all errors from that change key are added to the user interface (e.g., apply or redo). The grid rolls back from a change key. All errors from that change key are removed from the user interface (undo). When a new error comes in, if that change key is more recent than the current change key (e.g., if the user made an error-causing edit and then performed and before the validation came back) and there is not a more recent change on that cell (e.g., if the user made an error-causing edit and then made a non-error causing edit before validation on the previous edit failed)—in this case, it is desirable to not want to show the error user interface, as the cell is not currently in error), then that error is applied; otherwise, it is added to the tracking system, in case of undo.

Here, a grid change object 1802 passes record key information in an asynchronous server request 1804 to consumer objects of the server 1606 for data validation (using date validator 1508 of FIG. 15). The validation results can either be valid 1806 or not valid 1808, which is then passed back to the grid 110.

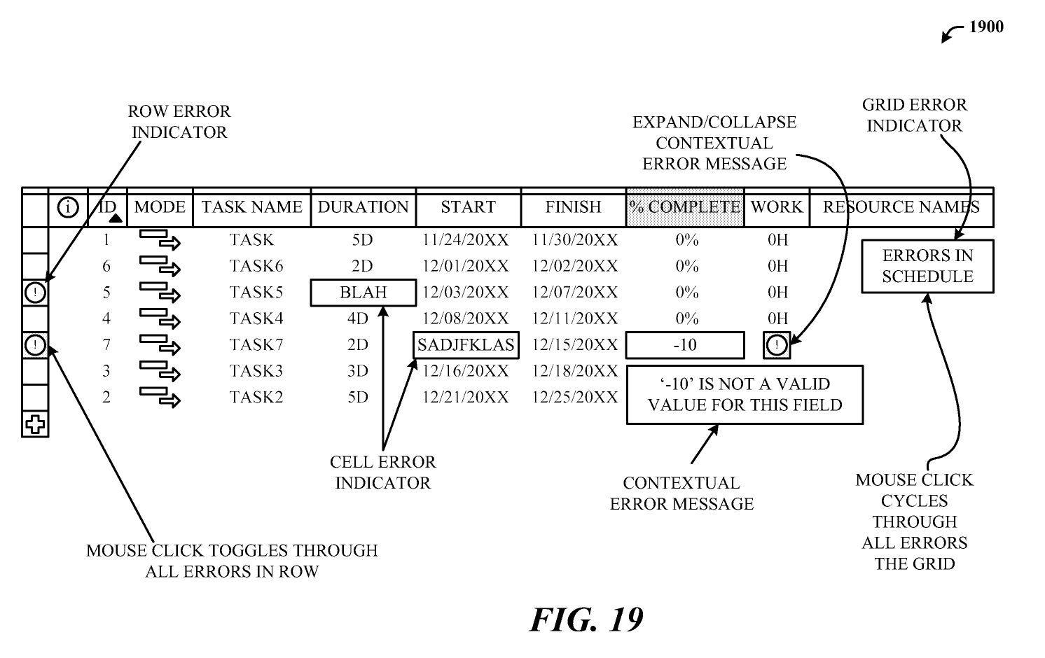

FIG. 19 illustrates a user interface (UI) 1900 that presents messages and visual cues related to validation at the cell level. The UI 1900 presents a row error indicator at the row header. The user can also navigate (click) through all errors in a row, for example, or all errors in the viewable grid and/or the entire set of grids on which work is being performed. The UI 1900 (in combination with the error handling component 1312) also presents visual cues related to a cell error indicator. An indicator (icon) proximate a cell can also facilitate presentation of a contextual message (if hidden) or hiding of the message (if presented). A generalized gird error message (“Errors in schedule”) can also be displayed to indicate that there are one or more errors in the schedule. Selection results in the ability to cycle (e.g., scroll) through all messages in the currently viewed grid (or all grids currently being worked on)

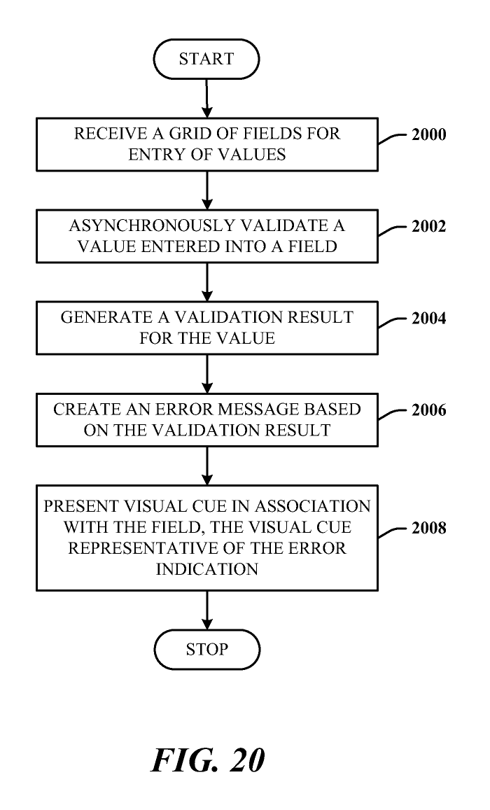

FIG. 20 illustrates a computer-implemented validation and error processing method in accordance with the disclosed architecture. At 2000, a grid is received of fields for the entry of values. At 2002, a value entered into a field is asynchronously validated. At 2004, a validation result is generated for the value. At 2006, an error message is created based on the validation result. At 2008, a visual cue is presented in association with the field, the visual cue representative of the error indication.

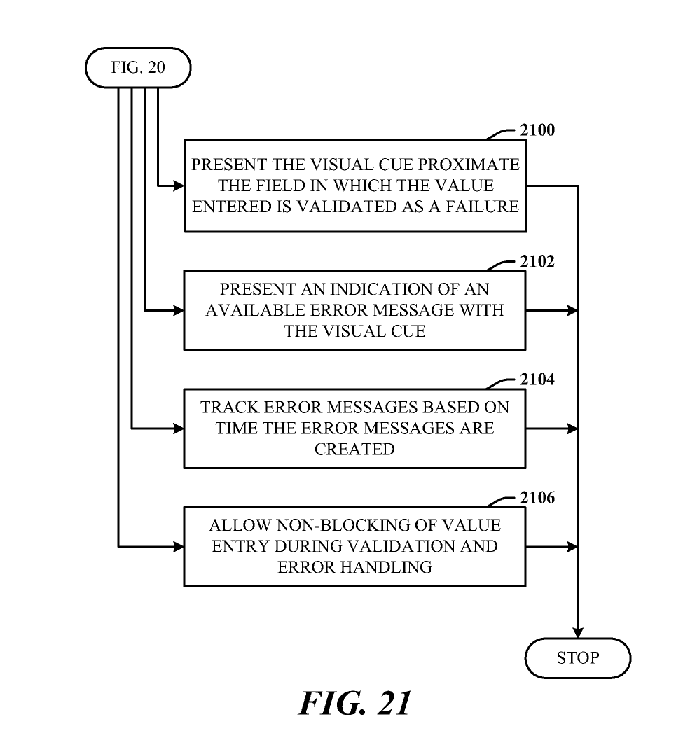

FIG. 21 illustrates additional aspects of the method of FIG. 20. At 2100, the visual cue is presented proximate the field in which the value entered is validated as a failure. At 2102, an indication of an available error message is presented with the visual cue. At 2104, error messages are tracked based on time the error messages are created. At 2106, non-blocking of value entry is allowed during validation and error handling.

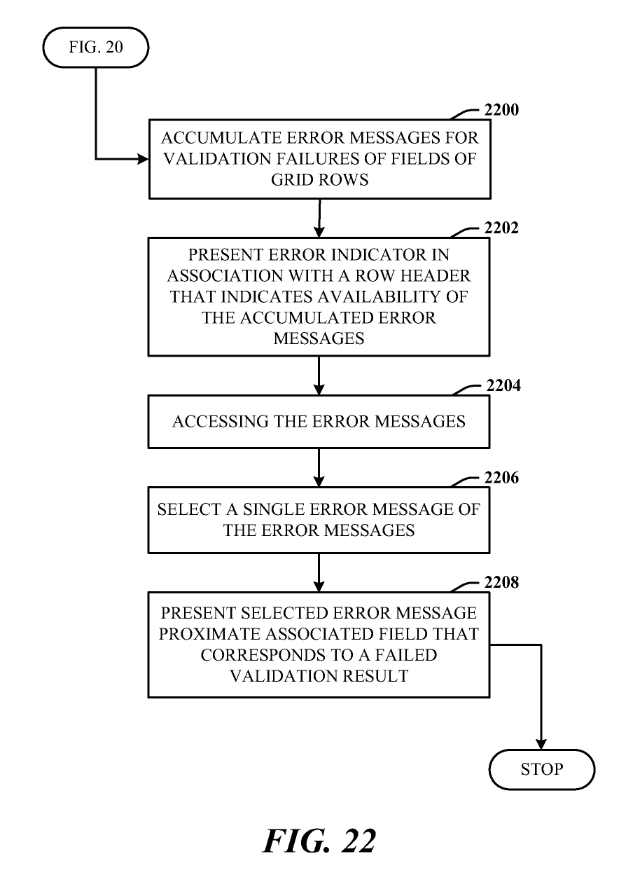

FIG. 22 illustrates additional aspects of the method of FIG. 20. At 2200, error messages are accumulated for validation failures of fields of grid rows. At 2202, an error indicator is presented in association with a row header that indicates availability of the accumulated error messages. At 2204, the error messages are accessed. At 2206, a single error message of the error messages is selected. At 2208, the selected error message is presented proximate an associated field that corresponds to a failed validation result.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

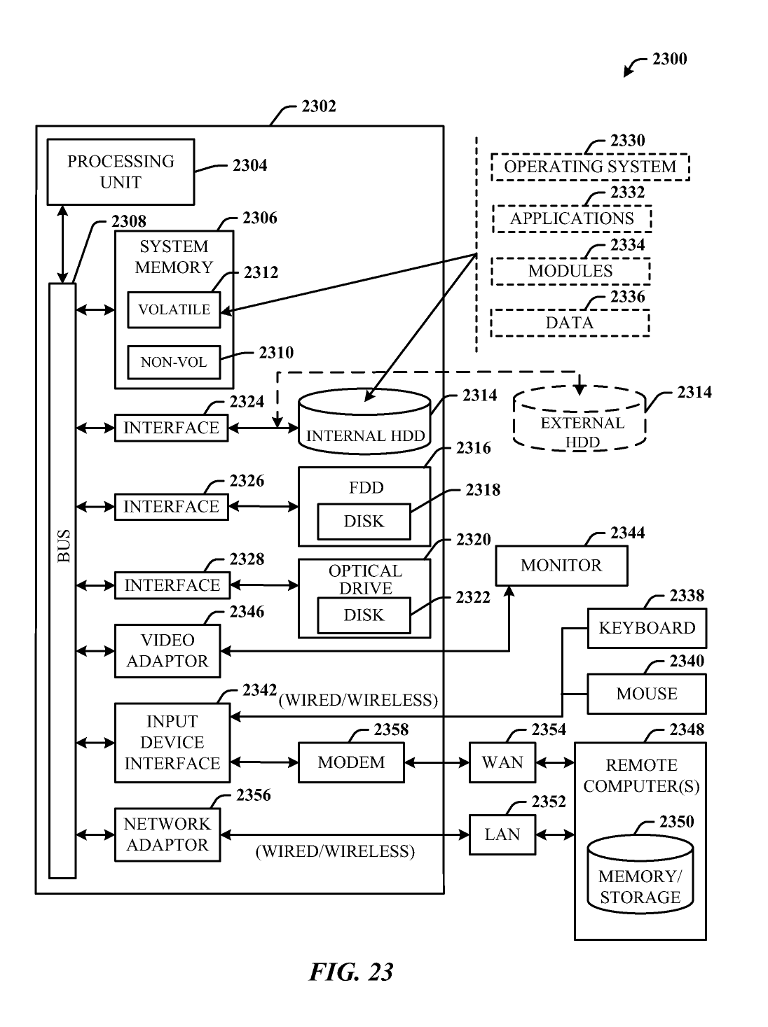

Referring now to FIG. 23, there is illustrated a block diagram of a computing system 2300 that executes asynchronous validation and error processing in accordance with the disclosed architecture. In order to provide additional context for various aspects thereof, FIG. 23 and the following description are intended to provide a brief, general description of the suitable computing system 2300 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 2300 for implementing various aspects includes the computer 2302 having processing unit(s) 2304, a computer-readable storage such as a system memory 2306, and a system bus 2308. The processing unit(s) 2304 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 2306 can include computer-readable storage (physical storage media) such as a volatile (VOL) memory 2310 (e.g., random access memory (RAM)) and non-volatile memory (NON-VOL) 2312 (e.g., ROM, EPROM, EEPROM, etc.). A basic input/output system (BIOS) can be stored in the non-volatile memory 2312, and includes the basic routines that facilitate the communication of data and signals between components within the computer 2302, such as during startup. The volatile memory 2310 can also include a high-speed RAM such as static RAM for caching data.

The system bus 2308 provides an interface for system components including, but not limited to, the system memory 2306 to the processing unit(s) 2304. The system bus 2308 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 2302 further includes machine readable storage subsystem(s) 2314 and storage interface(s) 2316 for interfacing the storage subsystem(s) 2314 to the system bus 2308 and other desired computer components. The storage subsystem(s) 2314 (physical storage media) can include one or more of a hard disk drive (HDD), a magnetic floppy disk drive (FDD), and/or optical disk storage drive (e.g., a CD-ROM drive DVD drive), for example. The storage interface(s) 2316 can include interface technologies such as EIDE, ATA, SATA, and IEEE 1394, for example.

One or more programs and data can be stored in the memory subsystem 2306, a machine readable and removable memory subsystem 2318 (e.g., flash drive form factor technology), and/or the storage subsystem(s) 2314 (e.g., optical, magnetic, solid state), including an operating system 2320, one or more application programs 2322, other program modules 2324, and program data 2326.

The one or more application programs 2322, other program modules 2324, and program data 2326 can include the entities and components of the systems described herein and methods represented by the flow charts herein, as well as other figures, for example.

Generally, programs include routines, methods, data structures, other software components, etc., that perform particular tasks or implement particular abstract data types. All or portions of the operating system 2320, applications 2322, modules 2324, and/or data 2326 can also be cached in memory such as the volatile memory 2310, for example. It is to be appreciated that the disclosed architecture can be implemented with various commercially available operating systems or combinations of operating systems (e.g., as virtual machines).

The storage subsystem(s) 2314 and memory subsystems (2306 and 2318) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 2302 and includes volatile and non-volatile internal and/or external media that is removable or non-removable. For the computer 2302, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 2302, programs, and data using external user input devices 2328 such as a keyboard and a mouse. Other external user input devices 2328 can include a microphone, an IR (infrared) remote control, a joystick, a game pad, camera recognition systems, a stylus pen, touch screen, gesture systems (e.g., eye movement, head movement, etc.), and/or the like. The user can interact with the computer 2302, programs, and data using onboard user input devices 2330 such a touchpad, microphone, keyboard, etc., where the computer 2302 is a portable computer, for example. These and other input devices are connected to the processing unit(s) 2304 through input/output (I/O) device interface(s) 2332 via the system bus 2308, but can be connected by other interfaces such as a parallel port, IEEE 1394 serial port, a game port, a USB port, an IR interface, etc. The I/O device interface(s) 2332 also facilitate the use of output peripherals 2334 such as printers, audio devices, camera devices, and so on, such as a sound card and/or onboard audio processing capability.

One or more graphics interface(s) 2336 (also commonly referred to as a graphics processing unit (GPU)) provide graphics and video signals between the computer 2302 and external display(s) 2338 (e.g., LCD, plasma) and/or onboard displays 2340 (e.g., for portable computer). The graphics interface(s) 2336 can also be manufactured as part of the computer system board.

The computer 2302 can operate in a networked environment (e.g., IP-based) using logical connections via a wired/wireless communications subsystem 2342 to one or more networks and/or other computers. The other computers can include workstations, servers, routers, personal computers, microprocessor-based entertainment appliances, peer devices or other common network nodes, and typically include many or all of the elements described relative to the computer 2302. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 2302 connects to the network via a wired/wireless communication subsystem 2342 (e.g., a network interface adapter, onboard transceiver subsystem, etc.) to communicate with wired/wireless networks, wired/wireless printers, wired/wireless input devices 2344, and so on. The computer 2302 can include a modem or other means for establishing communications over the network. In a networked environment, programs and data relative to the computer 2302 can be stored in the remote memory/storage device, as is associated with a distributed system. It will be appreciated that the network connections shown are exemplary and other means of establishing a communications link between the computers can be used.

The computer 2302 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

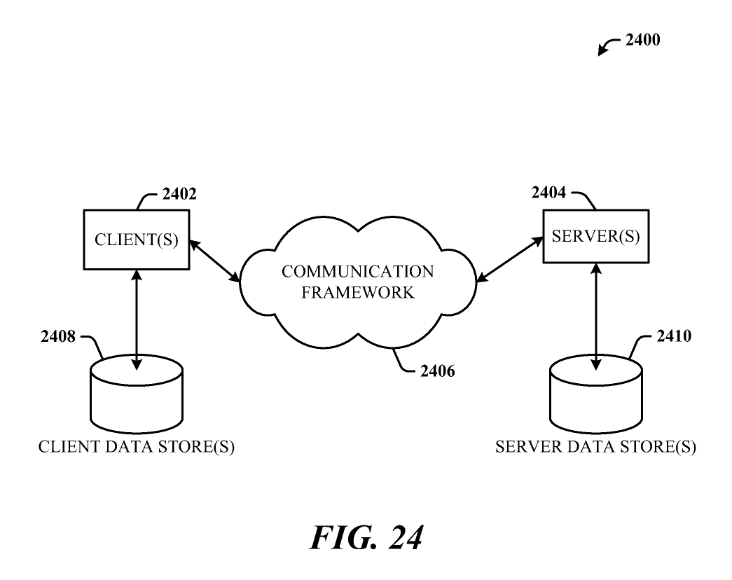

Referring now to FIG. 24, there is illustrated a schematic block diagram of a computing environment 2400 that executes asynchronous validation and error processing. The environment 2400 includes one or more client(s) 2402. The client(s) 2402 can be hardware and/or software (e.g., threads, processes, computing devices). The client(s) 2402 can house cookie(s) and/or associated contextual information, for example.

The environment 2400 also includes one or more server(s) 2404. The server(s) 2404 can also be hardware and/or software (e.g., threads, processes, computing devices). The servers 2404 can house threads to perform transformations by employing the architecture, for example. One possible communication between a client 2402 and a server 2404 can be in the form of a data packet adapted to be transmitted between two or more computer processes. The data packet may include a cookie and/or associated contextual information, for example. The environment 2400 includes a communication framework 2406 (e.g., a global communication network such as the Internet) that can be employed to facilitate communications between the client(s) 2402 and the server(s) 2404.

Communications can be facilitated via a wire (including optical fiber) and/or wireless technology. The client(s) 2402 are operatively connected to one or more client data store(s) 2408 that can be employed to store information local to the client(s) 2402 (e.g., cookie(s) and/or associated contextual information). Similarly, the server(s) 2404 are operatively connected to one or more server data store(s) 2410 that can be employed to store information local to the servers 2404.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented validation and error processing system having computer readable media that store executable instructions executed by a processor, comprising:
an application that stores and manipulates data asynchronously, the data includes values in association with fields of a grid;
a validation component that asynchronously performs validation checks of the association of the values and the fields to output a validation result; and
an error handling component that generates an error indication according to the validation result.

2. The system of claim 1, wherein the validation component asynchronously performs validation checks at a cell level of the grid.

3. The system of claim 1, wherein the validation component asynchronously performs validation checks at a row level of the grid.

4. The system of claim 1, further comprising a notification component that presents a message in association with the error indication.

5. The system of claim 1, wherein the error handling component generates and presents the error indication in association with a context in which the validation result is a failure.

6. The system of claim 1, wherein the error handling component presents multiple errors for review in response to user interaction.

7. The system of claim 1, wherein the manipulation of the data is non-blocked during validation and error handling.

8. The system of claim 1, wherein the application is a web application via which the data is manipulated during an editing session and validation checks are performed asynchronously.

9. The system of claim 1, wherein the error handling component populates a grid of field objects asynchronously with corresponding error indications based on respective validation result failures.

10. A computer-implemented validation and error processing system having computer readable media that store executable instructions executed by a processor, comprising:
a web application that allows asynchronous manipulation of data in a grid, the data associated with fields of the grid;
a validation component that asynchronously performs validation checks of the association of the data and the fields to output a validation result;
an error handling component that generates and presents a visual cue based on the validation result that is a failure; and
a notification component that enables access to a message in association with the visual cue.

11. The system of claim 10, wherein the validation component asynchronously performs validation checks at a cell level and row level of the grid.

12. The system of claim 10, wherein the error handling component generates and presents the visual cue in association with a field of the grid in which the validation result is the failure.

13. The system of claim 10, wherein the error handling component generates and presents multiple visual cues for interaction.

14. The system of claim 10, wherein the manipulation of the data is non-blocked during validation and error handling.

15. A computer-implemented validation and error processing method executed by a processor, comprising:
receiving a grid of fields for entry of values;
asynchronously validating a value entered into a field;
generating a validation result for the value;
creating an error message based on the validation result; and
presenting a visual cue in association with the field, the visual cue representative of the error indication.

16. The method of claim 15, further comprising presenting the visual cue proximate the field in which the value entered is validated as a failure.

17. The method of claim 15, further comprising presenting an indication of an available error message with the visual cue.

18. The method of claim 15, further comprising tracking error messages based on time the error messages are created.

19. The method of claim 15, further comprising allowing non-blocking of value entry during validation and error handling.

20. The method of claim 15, further comprising:
accumulating error messages for validation failures of fields of grid TOWS;
presenting an error indicator in association with a row header that indicates availability of the accumulated error messages;
accessing the error messages;
selecting a single error message of the error messages; and
presenting the selected error message proximate an associated field that corresponds to a failed validation result.
